(19) United States
(12) Patent Application Publication
(10) Pub. No.: US 2025/0094036 A1
(43) Pub. Date: Mar. 20, 2025

(54) ELECTRONIC DEVICE, AND UI PROVIDING METHOD THEREOF

(71) Applicant: SAMSUNG ELECTRONICS CO., LTD., Suwon-si (KR)

(72) Inventors: Byeongju LEE, Suwon-si (KR); Jangwon SEO, Suwon-si (KR)

(73) Assignee: SAMSUNG ELECTRONICS CO., LTD., Suwon-si (KR)

(21) Appl. No.: 18/964,963

(22) Filed: Dec. 2, 2024

Related U.S. Application Data
(63) Continuation of application No. PCT/KR2023/006788, filed on May 18, 2023.

(30) Foreign Application Priority Data
Jul. 15, 2022 (KR) 10-2022-0087728

(51) Int. Cl. G06F 3/0485; G06F 3/0481

(52) U.S. Cl. CPC G06F 3/0485; G06F 3/0481

(57) ABSTRACT

An electronic device which comprises: a display; and at least one processor which controls the display to display a user interface (UI) screen comprising a plurality of graphic user interface (GUI) items and indicating a focus GUI as any one GUI item from among the plurality of GUI items, and controls the display to move and display the plurality of GUI items along one direction according to a preset navigation input. Based on the preset navigation input, size information of the plurality of GUI items included in a section to be scrolled is identified, a scroll speed is identified based on the size information of the plurality of GUI items, and movement and display the plurality of GUI items along one direction is controlled based on the scroll speed.

### CROSS-REFERENCE TO RELATED APPLICATION

This application is a continuation application, under 35 U.S.C. § 111(a), of international application No. PCT/KR2023/006788, filed May 18, 2023, which claims priority under 35 U. S. C. § 119 to Korean Patent Application No. 10-2022-0087728, filed on Jul. 15, 2022, the disclosures of which are incorporated herein by reference in their entireties.

### BACKGROUND

### 1. Field

The present disclosure relates to an electronic device and a user interface (UI) providing method thereof, and more particularly, to an electronic device that controls a UI screen including graphic user interface (GUI) items of various sizes on the basis of a navigation input, and a user interface (UI) providing method thereof.

### 2. Description of the Related Art

Various types of electronic devices have been developed in accordance with the development of electronic technology. In particular, a display device such as a television (TV) may provide a variety of contents to meet needs of a user who wants newer and more diverse functions.

As types of content provided on the TV diversify and the number of content is gradually increased, the importance of a navigation function for navigating content desired by the user has been increased.

### SUMMARY

According to an embodiment of the present disclosure, provided is an electronic device including: a display; and at least one processor configured to control the display to display a user interface (UI) screen including a plurality of graphic user interface (GUI) items and indicating a focus GUI as any one GUI item among the plurality of GUI items, and control the display to move and display the plurality of GUI items along one direction based on a predetermined navigation input. The at least one processor is configured to identify size information of the plurality of GUI items which are included in a section to be scrolled based on the predetermined navigation input, identify a scroll speed based on the size information of each of the plurality of first GUI items, and control the display to move and display the plurality of GUI items along one direction based on the scroll speed.

The at least one processor may be configured to identify the scroll speed based on width information of each of the plurality of GUI items provided a scroll direction corresponding to the predetermined navigation input is a horizontal direction, and identify the scroll speed based on height information of the plurality of GUI items provided the scroll direction corresponding to the predetermined navigation input is a vertical direction.

The at least one processor may be configured to identify a minimum time required for a motion based on a value acquired by dividing a size of a smallest GUI item among the plurality of GUI items by the scroll speed, and update the scroll speed based on a perceivable motion time if the minimum time required for the motion is less than a predetermined perceivable motion time.

The plurality of GUI items may be first GUI items and the at least one processor may be configured to identify size information of second GUI items included in the section to be scrolled based on a second navigation input being identified after a scroll based on a first navigation input ends, and update the scroll speed based on the size information of each of the plurality of second GUI items.

The at least one processor may be configured to re-identify the section to be scrolled based on an update time point provided the plurality of first GUI items included in the section to be scrolled are updated based on at least one of real-time loading of the GUI items or looping of the GUI items while a scroll based on the predetermined navigation input is in progress, and update the scroll speed based on size information of other GUI items included in the re-identified section to be scrolled.

The at least one processor may be configured to update the scroll speed based on the scroll speed and information on a difference between a size of the display and a predetermined size provided the display has the predetermined size or more.

The display may be implemented as a rotatable display, and the at least one processor may be configured to control the display to move and display the plurality of GUI items in one direction based on the scroll speed while the display has a landscape mode, correct the scroll speed by reducing the scroll speed based on width information of the display in a portrait mode provided the display is rotated to the portrait mode, and control the display to move and display the plurality of GUI items in one direction based on the corrected scroll speed while the display has the portrait mode.

The at least one processor may be configured to control the display to move and display a plurality of first pixels corresponding to the plurality of GUI items and a plurality of second pixels each corresponding to an extra region between the plurality of GUI items in one direction at a constant speed based on the scroll speed.

The at least one processor may be configured to identify the scroll speed based on the size information of the plurality of GUI items and a basic scroll speed corresponding to the plurality of GUI items, and basic scroll speed information of each of the plurality of GUI items may be speed information calculated based on a scroll time equally allocated to each of the plurality of first GUI items and a number of pixels included in each of the plurality of GUI items in a scroll direction of the predetermined navigation input.

According to an embodiment of the present disclosure, provided is a user interface (UI) providing method of an electronic device, the method including: displaying a user interface (UI) screen including a plurality of graphic user interface (GUI) items and indicating a focus GUI as any one GUI item among the plurality of GUI items; and identifying size information of the plurality of first GUI items included in a section to be scrolled based on a predetermined navigation input; identifying a scroll speed based on the size information of the plurality of GUI items; and moving and displaying the plurality of GUI items along one direction based on the scroll speed.

According to an embodiment of the present disclosure, provided is non-transitory computer readable medium storing a computer instruction that causes an electronic device to perform an operation when executed by a processor of the electronic device, wherein the operation includes displaying a user interface (UI) screen including a plurality of graphic user interface (GUI) items and indicating a focus GUI as any one GUI item among the plurality of GUI items, and identifying size information of the plurality of GUI items included in a section to be scrolled based on a predetermined navigation input, identifying a scroll speed based on the size information of the plurality of first GUI items, and moving and displaying the plurality of GUI items along one direction based on the scroll speed.

### BRIEF DESCRIPTION OF THE DRAWINGS

FIG. 1 is a view for explaining an implementation example of an electronic device according to an embodiment of the present disclosure.

FIG. 2A is a block diagram showing a configuration of the electronic device according to an embodiment.

FIG. 2B is a view showing a detailed configuration of the electronic device in an implementation example according to an embodiment of the present disclosure.

FIG. 3 is a view for explaining a method for navigating graphic user interface (GUI) items according to an embodiment.

FIGS. 4A, 4B to 4C are views for explaining a method for identifying a scroll speed according to an embodiment.

FIGS. 5 and 6A, 6B to 6C are views for explaining a method for identifying a scroll speed based on a scroll direction according to an embodiment.

FIG. 7 is a view for explaining a method for identifying a scroll speed based on a scroll direction according to an embodiment.

FIG. 8 is a view for explaining a method for identifying a scroll speed by considering a perception feature according to an embodiment.

FIGS. 9 and 10 are views for explaining a method for updating the scroll speed according to an embodiment.

FIGS. 11 and 12 are views for explaining a method for updating the scroll speed according to an embodiment.

FIG. 13 is a view for explaining a method for updating the scroll speed based on a size of a display according to an embodiment.

FIG. 14 is a view for explaining a method for updating the scroll speed based on a display direction according to an embodiment.

### DETAILED DESCRIPTION

Hereinafter, the present disclosure is described in detail with reference to the accompanying drawings.

Terms used in the specification are briefly described, and the present disclosure is then described in detail.

General terms that are currently widely used are selected as terms used in embodiments of the present disclosure in consideration of their functions in the present disclosure. However, these terms may be changed based on the intention of those skilled in the art or a judicial precedent, the emergence of a new technique, and the like. In addition, in a specific case, terms arbitrarily chosen by an applicant may exist. In this case, the meanings of such terms are mentioned in detail in corresponding description portions of the present disclosure. Therefore, the terms used in the present disclosure need to be defined on the basis of the meanings of the terms and the contents throughout the present disclosure rather than simple names of the terms.

Terms “first”, “second”, and the like, may be used to describe various components. However, the components are not to be construed as being limited to these terms. The terms are used only to distinguish one component and another component from each other.

A term of a single number may include its plural number unless explicitly indicated otherwise in the context. It is to be understood that a term “include”, “formed of”, or the like used in this application specifies the presence of features, numerals, steps, operations, components, parts, or combinations thereof, mentioned in the specification, and does not preclude the presence or addition of one or more other features, numerals, steps, operations, components, parts, or combinations thereof.

An expression, “at least one of A or/and B” may indicate either “A or B”, or “both of A and B”.

In the present disclosure, a “module” or a “˜er/˜or” may perform at least one function or operation, and be implemented by hardware, software, or a combination of hardware and software. In addition, a plurality of “modules” or a plurality of “˜ers/˜ors” may be integrated in at least one module and implemented by at least one processor (not shown) except for a “module” or a “˜er/or” that needs to be implemented by specific hardware.

Hereinafter, the embodiments of the present disclosure are described in detail with reference to the accompanying drawings so that those skilled in the art to which the present disclosure pertains may easily practice the present disclosure. However, the present disclosure may be modified in various different forms, and is not limited to the embodiments provided herein. In addition, in the drawings, portions unrelated to the description are omitted to clearly describe the present disclosure, and similar portions are denoted by similar reference numerals throughout the specification.

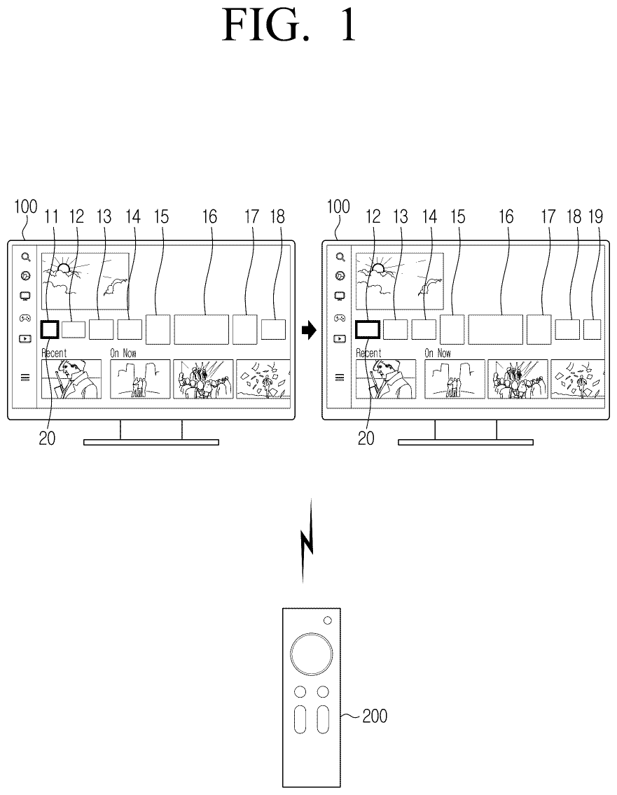

FIG. 1 is a view for explaining an implementation example of an electronic device according to an embodiment of the present disclosure.

Referring to FIG. 1, an electronic device 100 can be implemented as a display device capable of being remotely controlled by a remote control device 200. For example, the electronic device 100 may be applied to any device having a display function, such as a television (TV), a tablet personal computer (PC), a mobile phone, a desktop PC, a laptop PC, a personal digital assistant (PDA), a portable multimedia player (PMP), a large format display (LFD), a digital signage, a digital information display (DID), a video wall, a projector, a refrigerator, an air conditioner, an air purifier, a medical device, or the like without any limitation. Here, the remote control device 200 may be implemented as a remote controller, is not necessarily limited thereto, and may be implemented as a device which may be remotely controlled using an application such as a smartphone.

As an example, the electronic device 100 may provide a user interface (UI) screen including a plurality of graphic user interface (GUI) items 11, 12, 13, 14, 15, 16, 17, and 18, and control navigation operations of the plurality of GUI items on the basis of a navigation input received from the remote control device 200. As another example, the electronic device 100 may provide a content playback screen and adjust a content playback section on the basis of the navigation input received from the remote control device 200. In addition, the electronic device 100 can perform various control functions based on the type/function of the screen provided on the basis of the navigation input received from the remote control device 200.

According to an embodiment, the electronic device 100 can provide the UI screen including the plurality of GUI items 11, 12, 13, 14, 15, 16, 17, and 18 having various sizes and/or various ratios and a focus GUI 20 positioned on any one GUI item 11. In this case, the electronic device 100 can move and display the plurality of GUI items 11, 12, 13, 14, 15, 16, 17, and 18 in one direction on the basis of a predetermined navigation input, for example, a long press input, received from the remote control device 200. In this case, as shown in FIG. 1, a display position of the focus GUI 20 may be fixed, and as the plurality of GUI items 11, 12, 13, 14, 15, 16, 17, and 18 are moved, the focus GUI 20 may be positioned on another GUI item 12 adjacent to the GUI item 11, and a new GUI item 19 that is not provided on the UI screen can be provided on the UI screen.

In the above-described embodiment, if a scroll time (e.g., 120 ms) is equally allocated to each GUI item, the GUI item having a relatively large size may be scrolled and displayed at a fast speed, and the GUI item having a relatively small size may be scrolled and displayed at a slow speed. In this case, the speed may be changed based on the size of the GUI item, and a motion that is cut off for each section may thus occur, which may be perceived as slow due to a momentary lag or an overall navigation feeling may be perceived as lacking.

Accordingly, the following description describes in detail the various embodiments of maintaining a consistent scroll speed in a UI that includes the plurality of GUI items of various sizes and/or various ratios.

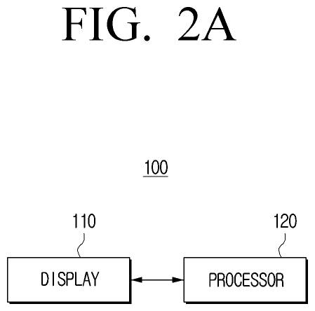

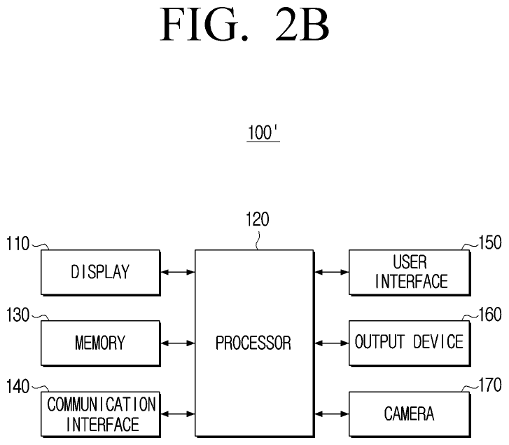

FIG. 2A is a block diagram showing a configuration of the electronic device according to an embodiment.

Referring to FIG. 2A, the electronic device 100 may include a display 110 and a processor 120.

The display 110 may be implemented as a display including a self-light emitting element or a display including a non self-light emitting element and a backlight. For example, the display 110 may be implemented as any of various types of displays such as a liquid crystal display (LCD), an organic light emitting diode (OLED) display, a light emitting diode (LED) display, a plasma display panel (PDP), and a quantum dot light-emitting diode (QLED) display. The display 110 may also include a driving circuit, a backlight unit, and the like, which may be implemented in a form such as an a-si thin film transistor (TFT), a low temperature poly silicon (LTPS) TFT, or an organic TFT (OTFT). Meanwhile, the display 110 can be implemented as a touch screen coupled with a touch sensor, a flexible display, a rollable display, a three-dimensional (3D) display, a display having a plurality of display modules physically connected with each other, or the like.

At least one processor 120 (hereinafter, the processor) may be electrically connected to the display 110 to thus control overall operations of the electronic device 100. At least one processor 120 may include one or more processors. Here, one or more processors may each be implemented as at least one software, at least one hardware, or a combination of at least one software and at least one hardware. As an example, software or hardware logic corresponding to at least one processor can be implemented within one chip. As another example, software or hardware logic corresponding to some of the plurality of processors may be implemented in one chip, or hardware logic corresponding to the remaining processors may be implemented in another chip.

In detail, the processor 120 may perform the operation of the electronic device 100 according to the various embodiments by executing at least one instruction stored in a memory.

The processor 120 according to an embodiment can be implemented as a digital signal processor (DSP), a microprocessor, a graphics processing unit (GPU), an artificial intelligence (AI) processor, a neural processing unit (NPU), or a time controller (TCON), which processes a digital image signal. However, the processor 120 is not limited thereto, may include at least one of a central processing unit (CPU), a micro controller unit (MCU), a micro processing unit (MPU), a controller, an application processor (AP), a communication processor (CP) or an advanced RISC machine (ARM) processor, or may be defined by these terms. In addition, the processor 120 may be implemented in a system-on-chip (SoC) or a large scale integration (LSI), in which a processing algorithm is embedded, or may be implemented in a form of an application specific integrated circuit (ASIC) or a field programmable gate array (FPGA).

According to an embodiment, the processor 120 can control the display 110 to display various types of screens capable of being controlled by the remote control device 200, such as the UI screen including the plurality of graphic user interface (GUI) items and the content playback screen.

As an example, the processor 120 can control the display 110 to display the user interface (UI) screen that includes the plurality of GUI items and the focus GUI positioned on any one GUI item among the plurality of GUI items. Here, the plurality of GUI items may each have a specific shape (for example, a rectangular shape, a rounded rectangular shape, a circular shape, or a diamond shape), and may be arranged in a specific direction such as a horizontal direction, a vertical direction, or a diagonal direction. The focus GUI may highlight a border around, the GUI item, is not necessarily limited thereto, and may highlight the entire GUI item or partially highlight the border around the GUI item.

According to an embodiment, the processor 120 can provide the UI screen including the plurality of GUI items having various sizes and/or various ratios and the focus GUI positioned on any one GUI item among the GUI items. In this case, the electronic device 100 can fix the position of the focus GUI, and then move and display the plurality of GUI items in one direction on the basis of the predetermined navigation input received from the remote control device 200, for example, the long press input.

FIG. 2B is a view showing a detailed configuration of an implementation example of the electronic device according to an embodiment of the present disclosure.

Referring to FIG. 2B, an electronic device 100′ may include the display 110, the processor 120, a memory 130, a communication interface 140, a user interface 150, an output device 160, and a camera 170. The description omits detailed descriptions of components that overlap the components shown in FIG. 2A among the components shown in FIG. 2B.

The memory 130 may be electrically connected to the processor 120, and can store data required for the various embodiments of the present disclosure. The memory 130 may be implemented in the form of a memory embedded in the electronic device 100′ or in the form of a memory detachable from the electronic device 100′, based on a data storage purpose. For example, data for driving the electronic device 100′ may be stored in the memory embedded in the electronic device 100, and data for an extension function of the electronic device 100 may be stored in the memory detachable from the electronic device 100. Meanwhile, the memory embedded in the electronic device 100′ may be implemented as at least one of a volatile memory (for example, a dynamic random access memory (DRAM), a static RAM (SRAM), or a synchronous dynamic RAM (SDRAM)), or a non-volatile memory (for example, an one time programmable read only memory (OTPROM), a programmable ROM (PROM), an erasable and programmable ROM (EPROM), an electrically erasable and programmable ROM (EEPROM), a mask ROM, a flash ROM, a flash memory (for example, a NAND flash or a NOR flash), a hard drive, or a solid state drive (SSD)). In addition, the memory detachable from the electronic device 100′ may be implemented in the form of a memory card (for example, a compact flash (CF), a secure digital (SD), a micro secure digital (Micro-SD), a mini secure digital (Mini-SD), an extreme digital (xD), or a multi-media card (MMC)), or an external memory capable of being connected to a universal serial bus (USB) port (for example, the USB memory).

As an example, the memory 130 may store at least one instruction for controlling the electronic device 100′ or a computer program including the instructions.

As an example, the memory 130 can store an image received from an external device (e.g., source device), an external storage medium (e.g., USB), an external server (e.g., web hard), or the like, that is, an input image, various data, information, or the like.

As an example, the memory 130 can store basic scroll speed information allocated to the GUI items having various sizes and/or ratios (hereinafter, size/ratio). For example, a different basic scroll speed may be stored for each ratio of the GUI item. In addition, the different basic scroll speeds may be stored for the GUI items having different sizes even if the GUI items have the same ratio. Here, the ratio of the GUI item may be a horizontal/vertical ratio of the GUI item having the rectangular shape. However, the GUI item may have the circular shape, the diamond shape, or the like, and even in this case, the ratio of the GUI item may be the horizontal/vertical ratio.

According to an embodiment, the memory 130 may be implemented as one memory for storing data generated in various operations according to the present disclosure. However, according to another embodiment, the memory 130 may be implemented to include a plurality of memories respectively storing different types of data or respectively storing data generated in different stages.

In the embodiment described above, various data are described as being stored in the external memory 130 of the processor 120. However, at least some of the data described above may be stored in an internal memory of the processor 120 according to at least one implementation example of the electronic device 100′ or the processor 120.

The communication interface 140 may be a component for communicating with the external device. For example, the communication interface 140 may receive an image signal in a streaming or downloading manner from the external device (e.g., source device), the external storage medium (e.g., USB memory), the external server (e.g., web hard) or the like by using a communication method such as an access point (AP) based wireless fidelity (Wi-Fi, i.e., wireless local area network (LAN)), a Bluetooth, a Zigbee, a wired/wireless local area network (LAN), a wide area network (WAN), Ethernet, IEEE 1394, a high definition multimedia interface (HDMI), a USB, a mobile high-definition link (MHL), audio engineering society/European broadcasting union (AES/EBU) communication, optical communication, or coaxial communication. Here, the image signal can be any one of the digital image signals among standard definition (SD), high definition (HD), full HD, and ultra HD images, and is not limited thereto. According to an embodiment, the communication interface 140 may be implemented as a remote control transmitter and receiver, and can receive a remote control signal transmitted from the remote control device 200. The remote control transmitter and receiver can receive or transmit the remote control signal from or to the external remote control device 200 through at least one of infrared communication, Bluetooth communication, or Wi-Fi communication.

The user interface 150 may be implemented as a device such as a button, a touch pad, a mouse or a keyboard, or may be implemented which may also perform a manipulation input function in addition to the above-described display function.

The output device 160 can output an audio signal. For example, the output device 160 can convert and amplify a digital audio signal processed by the processor 120 into an analog audio signal, and output the same. For example, the output device 160 may include at least one speaker unit, a digital to analog (D/A) converter, an audio amplifier, or the like, which may output at least one channel. As an example, the output device 160 may be implemented to output various multi-channel audio signals. In this case, the processor 120 can control the output device 160 to enhance and output the input audio signal corresponding to enhancement processing of the input image. For example, the processor 120 can convert an input 2-channel audio signal into a virtual multi-channel (e.g., 5.1 channel) audio signal, recognize a position of the electronic device 100′ and process the signal into a stereoscopic audio signal optimized for the corresponding space, or provide the audio signal optimized based on a type of the input image (e.g., content genre). As an example, the processor 120 can control the output device 160 to output audio feedback corresponding to UI feedback according to the various embodiments.

The camera 170 can be turned on and capture the image based on a predetermined event. The camera 170 may convert the captured image into an electrical signal and generate image data based on the converted signal. For example, an object may be converted into an electrical image signal by a charge coupled device (CCD), and the converted image signal may be amplified and converted into a digital signal and then signal-processed. However, the camera 170 may not be included in the electronic device 100′ based on an implementation example of the electronic device 100′.

The electronic device 100′ may further include a tuner or a demodulator based on an implementation example. The tuner (not shown) may receive a radio frequency (RF) broadcast signal by tuning a channel selected by a user or all pre-stored channels among the RF broadcast signals received through an antenna. The demodulator (not shown) may receive and demodulate a digital intermediate frequency (DIF) signal converted by the tuner, and also perform channel decoding or the like.

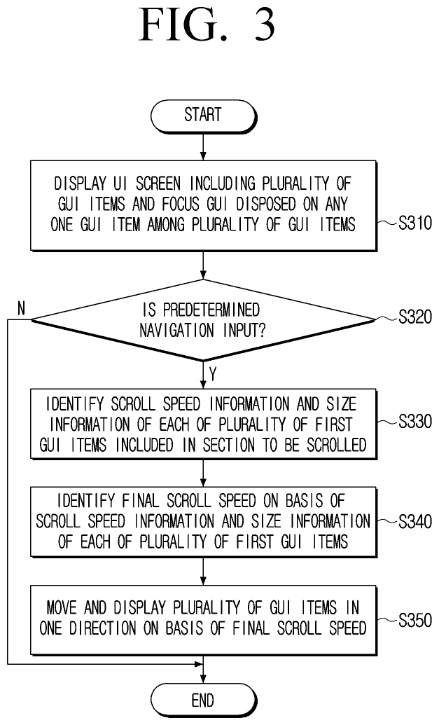

FIG. 3 is a view for explaining a method for navigating the graphic user interface (GUI) items according to an embodiment.

Referring to FIG. 3, the processor 120 can display the UI screen including the plurality of GUI items and the focus GUI disposed on any one GUI item among the plurality of GUI items (S310). As an example, at least some GUI items among the plurality of GUI items may have different ratios and/or sizes.

The processor 120 can identify size information of each of a plurality of first GUI items included in a section to be scrolled (S330) if the predetermined navigation input is identified (S320-Y). Here, the size information can include at least one of width or height information or at least one of ratio information.

As an example, the predetermined navigation input identified by the processor 120 may correspond to a user input for sequentially moving the plurality of GUI items. For example, the predetermined navigation input may be the long press input received from the remote control device 200, and is not limited thereto. For example, the predetermined navigation input may be a continuous key input received from a wheel input device, or the user input that is identical or similar thereto, and is not limited thereto. Here, the continuous key input may be an input for generating a threshold number of tick inputs at a threshold speed or higher from the wheel input device. The tick input may be an input corresponding to a basic manipulation unit of at least one of a wheel button or a touch panel for receiving a wheel input. If the wheel input device is implemented in hardware, the tick input may be the smallest unit capable of be recognized by the hardware and indicate that the device is physically moved one space. If the wheel input device is implemented in software, the tick input can be the smallest movement unit defined in software. Here, the wheel input device may be disposed in the remote control device 200, or may also be disposed in the electronic device 100.

As an example, the processor 120 can identify the plurality of first GUI items included in the section to be scrolled on the basis of a navigation input direction. For example, if the navigation input direction is a right direction, the section to be scrolled may include all of the plurality of first GUI items listed in the right direction (or the GUI items that are not displayed on the UI screen but included in a list in the right direction), or include the plurality of first GUI items currently displayed on the UI screen in the right direction. However, the present disclosure is not limited thereto, and the section to be scrolled may include the GUI items corresponding to N times the number of the plurality of first GUI items currently displayed on the UI screen among the plurality of first GUI items listed in the right direction. In addition, the section to be scrolled can be determined in various ways.

Next, the processor 120 can identify the scroll speed on the basis of the size information of each of the plurality of first GUI items (S340). For example, the processor 120 can identify the scroll speed on the basis of basic scroll speed information and the size information of each of the plurality of first GUI items. For example, the processor 120 can identify the scroll speed on the basis of the size information and predefined time information of each of the plurality of first GUI items. For example, the processor 120 can identify the scroll speed on the basis of the size information and weight information of each of the plurality of first GUI items. In addition, the scroll speed can be identified in various ways, and a detailed method thereof is described below.

Next, the processor 120 can control the display 110 to move and display the plurality of GUI items in one direction on the basis of the scroll speed (S350).

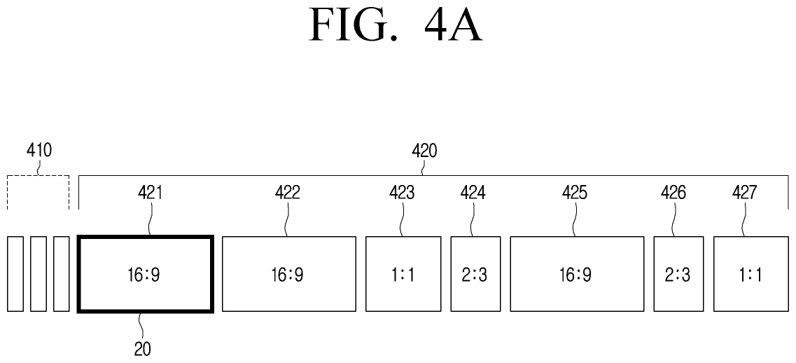

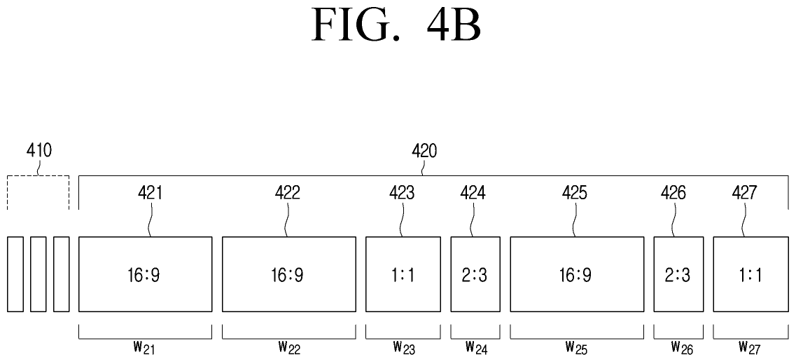

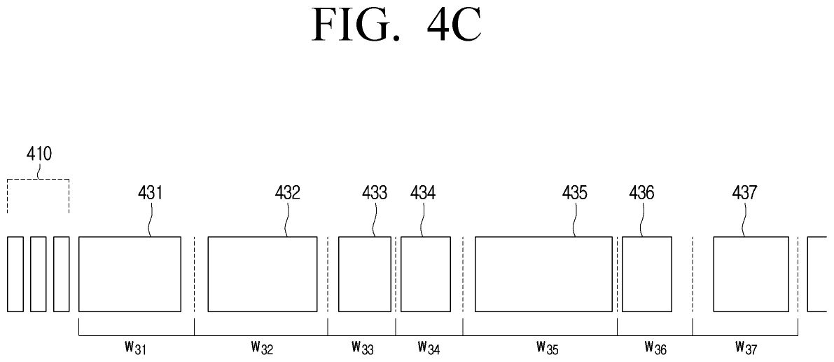

FIGS. 4A to 4C are views for explaining a method for identifying the scroll speed according to an embodiment.

According to an embodiment, as shown in FIG. 4A, it can be assumed that a focus GUI 20 is positioned on a specific GUI item 421 displayed on the UI screen, the navigation input in the right direction is identified, and a plurality of GUI items 421 to 427 are identified as a section 420 to be scrolled. Here, a section 410 may be a previous scroll section that is already scrolled.

According to an embodiment, the processor 120 can identify the scroll speed on the basis of the size information of each of the plurality of first GUI items and the basic scroll speed information corresponding to each of the plurality of first GUI items. As an example, the basic scroll speed of the first GUI item may be a predefined speed on the basis of a ratio/size of each of the first GUI items. For example, the basic scroll speed can be a speed calculated on the basis of the scroll time equally allocated to each of the plurality of first GUI items and a size of each of the plurality of first GUI items.

As an example, it can be assumed that the GUI items having the same ratio have the same size, and an appropriate basic scroll speed (or appropriate scroll speed) is defined for each ratio of the GUI items. For example, the appropriate scroll speed for a 16:9 item may be v1, the appropriate scroll speed for a 2:3 item may be v2, and the appropriate scroll speed for a 1:1 item may be v3.

In this case, assuming that a total of N items exist in the scroll section, and there are n1 16:9 items, n2 2:3 items, and n3 1:1 items, an optimal scroll speed V can be calculated as shown in Equation 1 below on the basis of the appropriate scroll speed of each GUI item and the number of GUI items corresponding to each ratio.

$$V = \frac{{V}_{1} * {n}_{1} + {V}_{2} * {n}_{2} + {V}_{3} * {n}_{3}}{N} . \qquad [ Equation 1 ]$$

In the embodiment above, the scroll speed is described as being calculated on the basis of the predetermined appropriate speed of each GUI item, and the present disclosure is not necessarily limited thereto.

According to an embodiment, the scroll speed may also be calculated by dividing a size of the section to be scrolled, for example, the number of pixels corresponding to a scroll direction (for example, horizontal pixels), by the scroll time. Here, the scroll time can be a predefined time based on the size (or length) of the section to be scrolled or the number of GUI items included in the section to be scrolled. For example, the scroll speed can be calculated as the number of pixels per hour.

As an example, as shown in FIG. 4B, the processor 120 can calculate a size (or length) of the section 420 to be scrolled on the basis of a size w21, w22, w23, w24, w26, or w27 of each of the plurality of identified GUI items 421 to 427, and calculate the scroll speed by dividing the calculated size by the predefined scroll time. For example, the size of the section 420 to be scrolled can be calculated as its length in pixel units. Here, if each of extra regions between the plurality of GUI items 421 to 427 is constant, the size (or length) of the section 420 to be scrolled can be calculated by adding a value acquired by multiplying a length of the region by the number of regions to the sizes of the plurality of GUI items 421 to 427. The predefined scroll time can be a time determined by the size of the section to be scrolled or the number of GUI items included in the section to be scrolled.

As an example, as shown in FIG. 4C, the processor 120 can calculate a plurality of GUI items 431 to 437 and each size of extra regions w31, w32, w33, w34, w36, and w37 between the plurality of GUI items 431 to 437 on the basis of the size of the section 420 to be scrolled, for example, its length in the pixel units, and calculate the scroll speed by dividing its calculated size by the predefined scroll time.

As an example, in case of applying Equation 1 to an embodiment in FIG. 4C, the processor 120 can divide each extra region based on the center of each extra region, and allocate the left extra region to the previous GUI item and the right extra region to the next GUI item. For example, the processor 120 can calculate the scroll speed corresponding to the section to be scrolled by applying the speed corresponding to GUI item 431 to a pixel region corresponding to w31, and applying the speed corresponding to GUI item 432 to a pixel region corresponding to w32.

As an example, the processor 120 can acquire the scroll speed by inputting the size information and number information of the plurality of GUI items included in the section to be scrolled into a trained neural network model. In this case, the neural network model can be trained to output the scroll speed by learning not only the size and number information of the GUI item but also information such as the perception feature, the size of the display, or a display mode, which are described below. In addition, the neural network model may also learn usage history information, user profile information, or the like.

As an example, the processor 120 may acquire the predefined scroll speed based on the length of the section to be scrolled. For example, the predefined scroll speed can be mapped to the section to be scrolled for each length and stored in the memory 130 in the form of a lookup table. In this case, even if the section to be scrolled has the same length, a different scroll speed may be mapped based on the ratio or number of item having a different size and included in the section to be scrolled.

As an example, the processor 120 can also calculate the scroll speed by multiplying a reference scroll speed by a predetermined weight corresponding to the length of the section to be scrolled. In this case, even if the section to be scrolled has the same length, a different weight may be applied based on the ratio or number of item having a different size and included in the section to be scrolled.

As an example, the processor 120 may update scroll information by considering the usage history information, the user profile information, etc. For example, the processor 120 may also update the scroll information on the basis of user history information, such as a scroll speed adjustment history, a scroll repetition history or a menu manipulation speed, a user age, or the like.

According to an embodiment, the processor 120 can move and display a plurality of first pixels corresponding to the plurality of GUI items and a plurality of second pixels each corresponding to the extra region between the plurality of GUI items in one direction at a constant speed on the basis of the scroll speed. Accordingly, even if the GUI items having different sizes and/or ratios are mixed in rows or columns of the UI screen, the processor 120 can maintain the constant scroll speed to thus provide a smooth scroll motion during the navigation.

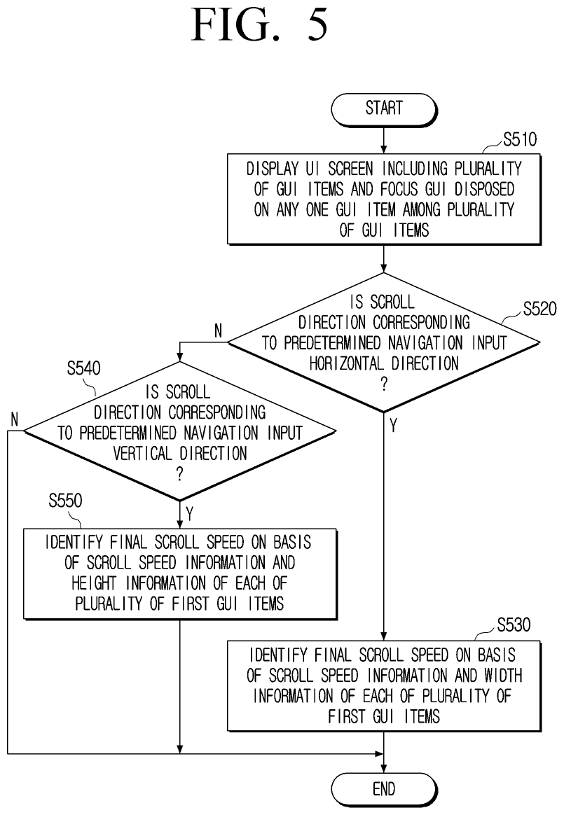

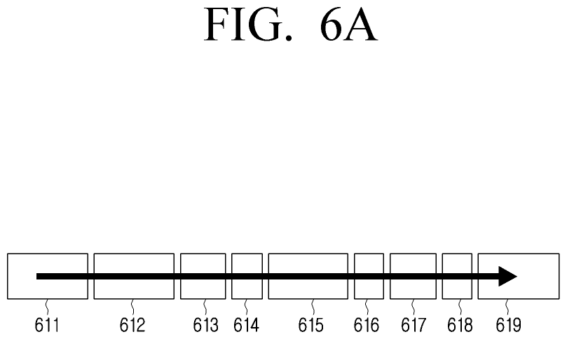

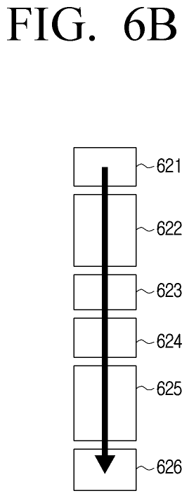

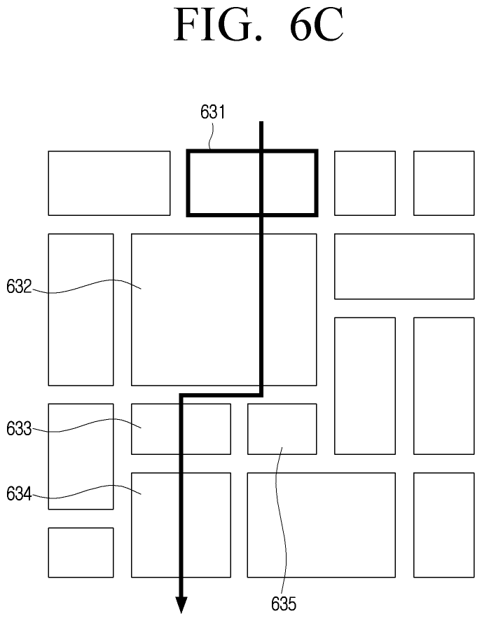

FIGS. 5 and 6A to 6C are views for explaining a method for identifying the scroll speed based on a scroll direction according to an embodiment.

Referring to FIG. 5, the processor 120 can display the UI screen including the plurality of GUI items and the focus GUI disposed on any one GUI item among the plurality of GUI items (S510).

The processor 120 can identify the scroll speed on the basis of the width information of each of the plurality of first GUI items (S530) if the scroll direction corresponding to the predetermined navigation input is the horizontal direction (S520-Y).

For example, if the scroll direction is the horizontal direction as shown in FIG. 6A, the processor 120 can identify the scroll speed on the basis of the width information of each of the plurality of GUI items 611 to 619 arranged in the horizontal direction. For example, as shown in Equation 1, the processor 120 can acquire the scroll speed by multiplying the number of items corresponding to the same width by the appropriate scroll speed corresponding to the item, adding these calculated values, and then dividing the same by the total number of items.

Alternatively, the processor 120 can acquire the scroll speed by dividing the horizontal length of the section to be scrolled by the predefined scroll time as described above. The predefined scroll time can be the time determined by the size of the section to be scrolled or the size/number of GUI items included in the section to be scrolled.

Alternatively, the processor 120 may acquire the predefined scroll speed based on the horizontal length of the section to be scrolled. For example, the predefined scroll speed can be mapped to the section to be scrolled for each length and stored in the memory 130 in the form of the lookup table. In this case, even if the section to be scrolled has the same length, the different scroll speed may be mapped based on the ratio or number of item having the different size and included in the section to be scrolled.

Alternatively, the processor 120 can calculate the scroll speed by multiplying the reference scroll speed by the predetermined weight corresponding to the horizontal length of the section to be scrolled. In this case, even if the section to be scrolled has the same length, a different weight may be applied based on the ratio or number of item having the different size and included in the section to be scrolled.

The processor 120 can identify the scroll speed on the basis of the height information of each of the plurality of first GUI items (S550) if the scroll direction corresponding to the predetermined navigation input is the vertical direction (S540-Y).

For example, if the scroll direction is the vertical direction as shown in FIG. 6B, the processor 120 can identify the scroll speed on the basis of the height information of each of a plurality of GUI items 621 to 626 arranged in the vertical direction. For example, as shown in Equation 1, the processor 120 can acquire the scroll speed by multiplying the number of items corresponding to the same height by the appropriate scroll speed corresponding to the item, adding these calculated values, and then dividing the same by the total number of items. In addition, the processor 120 can acquire the scroll speed in the same/similar way as the horizontal scroll.

For example, if the GUI items are arranged in a frame shape and the scroll direction is the vertical direction, as shown in FIG. 6C, the processor 120 can identify the scroll speed on the basis of the height information of each of a plurality of GUI items 631 to 634 arranged in the vertical direction. If two GUI items 633 and 635 are disposed in the vertical direction based on the specific GUI item 632 disposed in the scroll direction as shown in the drawing, the processor 120 can scroll to the GUI item 633 at a predefined position (e.g., left). For example, as shown in Equation 1, the processor 120 can acquire the scroll speed by multiplying the number of GUI items corresponding to the same height by the appropriate scroll speed corresponding to the item, adding these calculated values, and then dividing the same by the total number of items. In addition, the processor 120 can acquire the scroll speed in the same/similar way as the horizontal/vertical scroll.

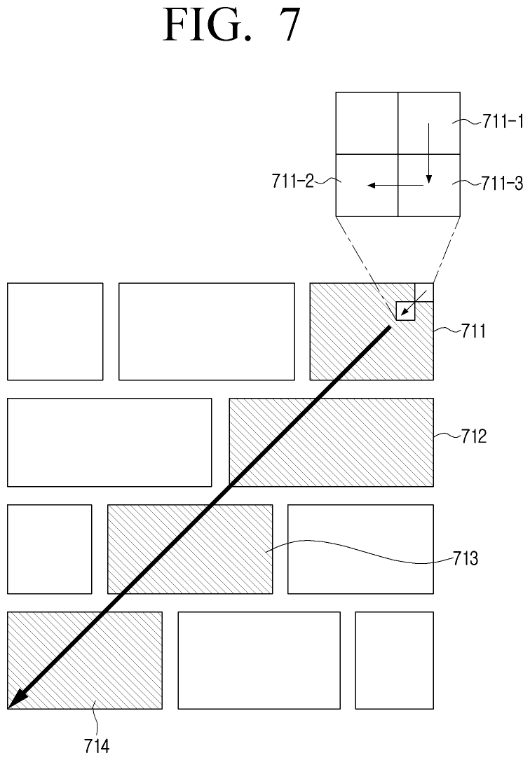

FIG. 7 is a view for explaining a method for identifying the scroll speed based on the scroll direction according to an embodiment.

If the navigation input is identified in the diagonal direction as shown in FIG. 7, the processor 120 can calculate the scroll speed on the basis of the sizes of the GUI items disposed in the diagonal direction. For example, the processor 120 can calculate a movement speed from a specific pixel 711-1 to a left pixel 711-2 in the diagonal direction on the basis of a movement distance from the specific pixel 711-1>a lower pixel 711-3>the left pixel 711-2. For example, the processor 120 can identify the distance in the same way for all the pixels arranged in the diagonal direction and included in the scroll section, and calculate the scroll speed by dividing the identified distance by the predefined scroll time. Here, the predefined scroll time can be a time determined on the basis of the size and number of GUI items disposed in the diagonal direction.

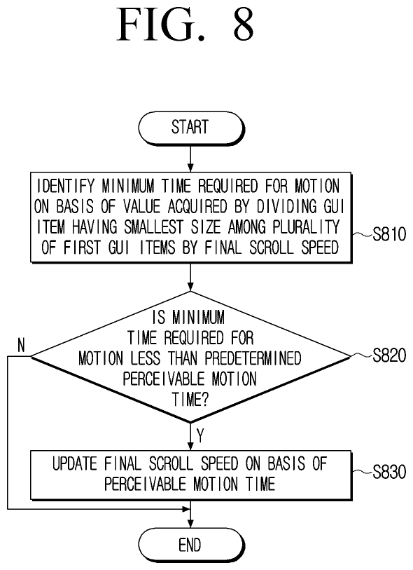

FIG. 8 is a view for explaining a method for identifying the scroll speed by considering the perception feature according to an embodiment.

According to an embodiment, the processor 120 can update the scroll speed on the basis of a perceivable motion time for the smooth scroll motion. The reason is that the relatively small GUI item may appear to jump momentarily if the scroll speed v is excessively fast.

Accordingly, referring to FIG. 8, the processor 120 can identify the minimum time required for the motion on the basis of the scroll speed and the size of the smallest GUI item among the plurality of first GUI items included in the section to be scrolled (S810). In detail, the processor 120 can identify the minimum time required for the motion on the basis of a value acquired by dividing the size of the smallest GUI item among the plurality of first GUI items by the scroll speed. For example, the processor 120 can calculate the minimum time required for a motion t on the basis of Equation 2.

$$t = \frac{W}{V} . \qquad [ Equation 2 ]$$

Here, t indicates the minimum time required for the motion, W indicates the size (e.g., width or height) of the smallest GUI item included in the section to be scrolled, and V indicates the scroll speed.

Next, the processor 120 may identify whether the minimum time required for the motion is less than the predetermined perceivable motion time (S820). Here, the predetermined perceivable motion time may be a value acquired on the basis of existing research, and can be 100 ms for example (https://www.nngroup.com/articles/response-times-3-important-limits/, and https://www.nngroup.com/articles/animation-duration/).

The processor 120 can update the scroll speed on the basis of the perceivable motion time (S830) if the minimum time required for the motion is less than the predetermined perceivable motion time (S820-Y). For example, the processor 120 can update the scroll speed to a value of 100 ms or more if the minimum time required for the motion t is less than 100 ms. For example, the processor 120 can calculate the updated scroll speed by considering a size of the display 110, a mode of the display 110 (i.e., landscape or portrait mode), an average size of the GUI items included in the scroll section, the number of GUI items for each size/ratio, or the like.

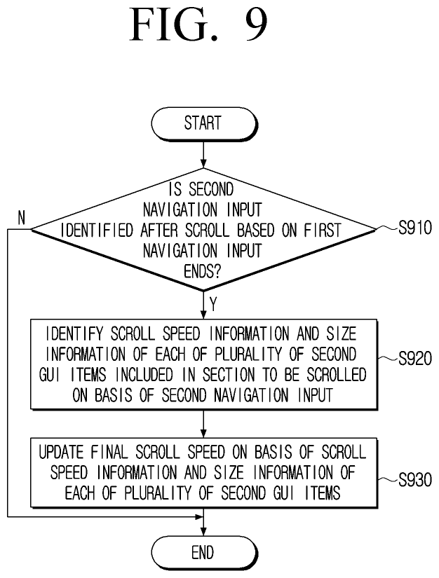

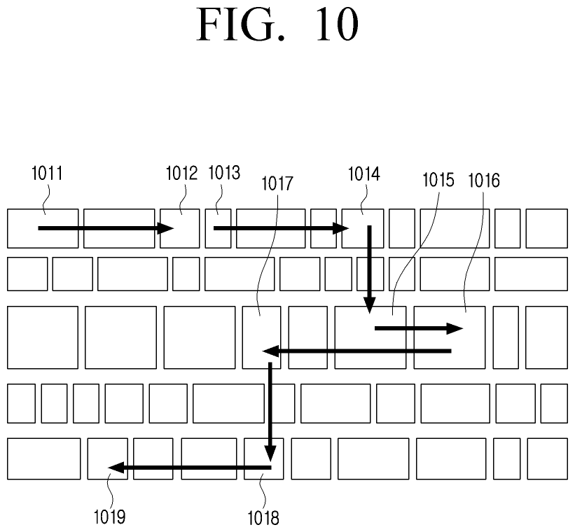

FIGS. 9 and 10 are views for explaining a method for updating the scroll speed according to an embodiment.

According to an embodiment, the processor 120 can update the scroll speed in real time in response to a context change. For example, the processor 120 can update the scroll speed based on a new GUI item if a new scroll is provided in the same or different direction after the scroll starts and ends.

Referring to FIG. 9, the processor 120 can identify size information of each of the plurality of second GUI items included in the section to be scrolled on the basis of a second navigation input (S920) if the second navigation input is identified after the scroll based on a first navigation input ends (S910-Y).

Next, the processor 120 can update the scroll speed on the basis of the size information of each of the plurality of second GUI items (S930).

For example, as shown in FIG. 10, the processor 120 can identify the section to be scrolled based on a GUI item 1013, and identify the scroll speed corresponding to the second navigation input on the basis of an identified target section if the first navigation input in the right direction is identified on in a GUI item 1011, and the second navigation input in the right direction is identified on the GUI item 1013 after the right scroll corresponding to the first navigation input ends on a GUI item 1012.

Next, the processor 120 can identify the section to be scrolled based on a GUI item 1014, and identify the scroll speed corresponding to a third navigation input on the basis of the identified target section if the third navigation input in a downward direction is identified on the same GUI item 1014 after the right scroll corresponding to the second navigation input ends on the GUI item 1014. In this way, the processor 120 can update the scroll speed for each of GUI items 1015, 1016, 1017, 1018, and 1019 identified by each navigation input, and perform the scroll corresponding to each navigation input based on the updated scroll speed.

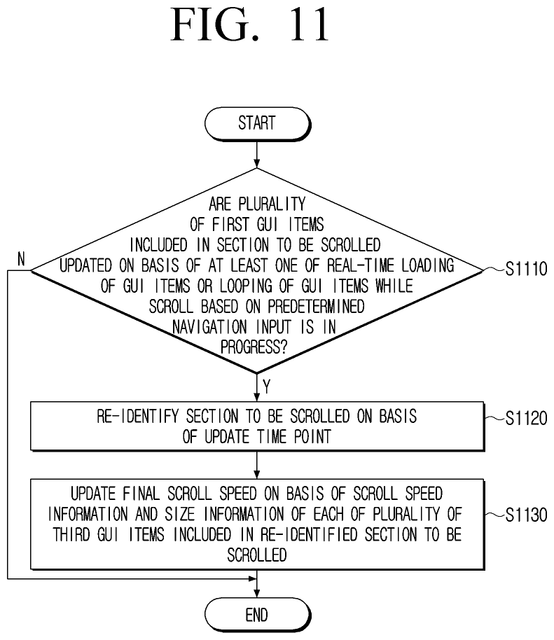

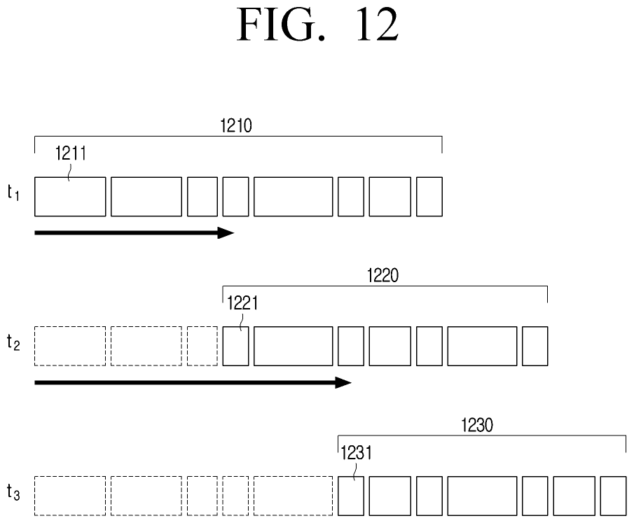

FIGS. 11 and 12 are views for explaining a method for updating the scroll speed according to an embodiment.

According to an embodiment, the processor 120 can update the scroll speed by re-identifying the section to be scrolled based on an update time point if the GUI item included in the section to be scrolled is updated while the scroll is in progress.

Referring to FIG. 11, the processor 120 may identify whether the plurality of first GUI items included in the section to be scrolled are updated while the scroll based on the predetermined navigation input is in progress (S1110). As an example, the processor 120 may update the GUI items included in the section to be scrolled on the basis of at least one of real-time loading of the GUI items or looping of the GUI items. Here, the looping of GUI items can include cases where the item, such as the first item in the list, is added to the section to be scrolled after the last item in the list.

The processor 120 can re-identify the section to be scrolled on the basis of the update time point (S1120) if the plurality of first GUI items included in the section to be scrolled are updated (S1110-Y).

Next, the processor 120 can update the scroll speed on the basis of size information of each of the plurality of third GUI items included in the re-identified section to be scrolled (S1130).

For example, as shown in FIG. 12, the processor 120 can perform the scroll based on the scroll speed identified based on a section 1210 to be scrolled, for example, based on v1 if the navigation input is identified on a GUI item 1211 at a time point t1. The processor 120 can update the scroll speed based on the corresponding time point if the GUI item included in the section to be scrolled is identified as updated at a specific time point t2 while the scroll is in progress at the speed v1. For example, the processor 120 can update the scroll speed to v2 based on a section 1220 to be scrolled after a GUI item 1221 if the GUI item included in the section 1220 to be scrolled is identified as updated at a time point t2 at which the scroll progresses to the GUI item 1221. Accordingly, the scroll after the GUI item 1221 can be performed at the updated scroll speed v2.

In addition, the processor 120 can update the scroll speed based on a section 1230 to be scrolled after a GUI item 1231 if the GUI item included in the section 1230 to be scrolled is identified as updated at a time point t3 at which the scroll progresses to the GUI item 1231. Accordingly, the scroll after the GUI item 1231 can be performed at the updated scroll speed v3.

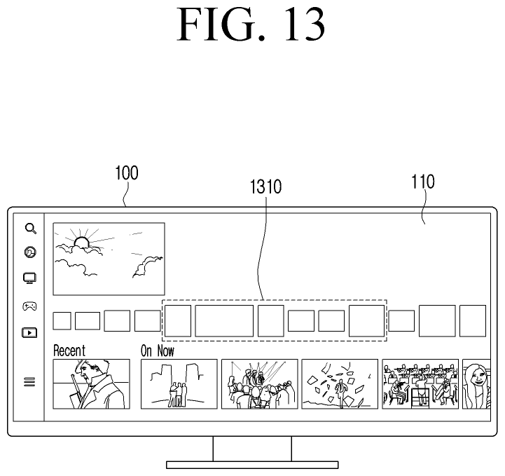

FIG. 13 is a view for explaining a method for updating the scroll speed based on the size of the display according to an embodiment.

According to an embodiment, the processor 120 can update the scroll speed on the basis of the scroll speed and information on a difference between the size of the display 110 and a predetermined size if the display 110 has the predetermined size or more. For example, even in case of having the same resolution, the GUI items may have different physical sizes based on the size of the display 110. Accordingly, a user perception speed of scrolling the UI screen may be faster as the size of the display 110 is larger. The reason is that a physical movement distance for the same amount of time becomes longer.

As a screen size is increased in recent years, a large screen of 75″ or more may no longer fit within a central viewing angle of 30 degrees of a person at a viewing distance of 3 m. In this case, in the horizontal scroll that moves across the entire screen, user eye and head movements may be increased during the manipulation, which may increase fatigue and reduce efficiency in receiving information. Accordingly, the processor 120 according to an embodiment may correct the scroll speed on the basis of the size of the display 110. For example, if the scroll direction and a screen direction are the same horizontal direction as shown in FIG. 13, a screen width 1310 having the central viewing angle of 30 degrees at the viewing distance of 3 m can be defined as a ‘reference screen width’.

According to an embodiment, the processor 120 can correct the scroll speed relatively slowly if a target screen width is larger than the reference screen width. The reason is to allow the user to better accept the information by giving the user some time to perceive the scroll section even if the scroll section deviates from the central viewing angle. If the scroll direction and the screen direction are the vertical direction, the processor 120 can correct the scroll speed in the same way, and correct the scroll speed based on a target screen height and a reference screen height.

As an example, a value R, which indicates a ratio of the target screen width to the reference screen width, can be defined as shown in Equation 3 below.

$$R = k * \frac{target screen width - reference screen width}{reference screen width} . \qquad [ Equation 3 ]$$

In this case, the corrected scroll speed can be calculated as shown in Equation 4 below.

$$RevisedVelocity = \frac{V}{R} . \qquad [ Equation 4 ]$$

Here, V indicates the scroll speed, and R indicates the value calculated in Equation 3.

However, the embodiment described above is only an example of correcting the scroll speed on the basis of the screen width, and the scroll speed can be corrected in various ways. For example, the processor 120 can acquire the corrected scroll speed by multiplying the weight predefined based on the value R to the scroll speed. In this case, the weight predefined based on the value R can be stored in the form of the lookup table or received from the external device.

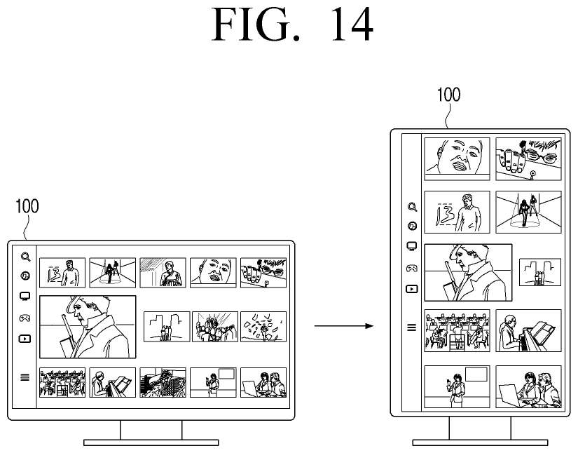

FIG. 14 is a view for explaining a method for updating the scroll speed based on a display direction according to an embodiment.

According to an embodiment, the display 110 can be implemented as a rotatable display. For example, if a 16:9 screen is rotated vertically, the screen may have a ratio of 9:16 which is a smaller horizontal width. In this case, if the user scrolls the UI screen, a time at which the GUI items included in the list are exposed on the screen may be decreased, thus making it difficult for the user to grasp the information. Accordingly, if the display 110 is rotated from the landscape mode to the portrait mode, the processor may correct the scroll speed to be relatively a little slower as the screen width is reduced. Here, an amount of speed reduction may be either predefined or determined by applying the predetermined weight. Here, the predetermined weight can be a value defined on the basis of a width/height ratio of the screen, the screen size, a difference in the size of the GUI item in the landscape mode and the portrait mode, etc.

As an example, as shown on a left side of FIG. 14, the processor 120 can move and display the plurality of GUI items in one direction on the basis of the scroll speed calculated based on the navigation input while the display 110 has the landscape mode.

Next, if the display 110 is rotated to the portrait mode based on the predetermined event, the processor 120 may correct the scroll speed on the basis of width information of the display 110 in the portrait mode, and the processor 120 can move and display the plurality of GUI items in one direction based on the corrected scroll speed. Here, the predetermined event can be a user command, a content ratio change, or the like.

For example, the processor 120 can calculate the corrected scroll speed in the portrait mode by multiplying the scroll speed in the landscape mode by the predetermined weight. For example, the weight based on a ratio of the screen width in the landscape mode and the screen width in the portrait mode may be stored in the form of the lookup table, or may be received from the external device.

Accordingly, according to the various embodiments described above, even if the GUI items having various sizes/ratios are mixed in the rows or columns of the UI screen, the processor 120 can maintain the constant scroll speed to thus provide the smooth scroll motion during the navigation.

Meanwhile, the methods according to the various embodiments of the present disclosure described above may be implemented in the form of an application capable of being installed in a conventional electronic device. Alternatively, at least some of the methods according to the various embodiments of the present disclosure described above can be performed using a deep learning-based artificial intelligence model, that is, the trained network model.

In addition, the methods according to the various embodiments of the present disclosure described above may be implemented only by the software upgrade or hardware upgrade of the conventional electronic device.

In addition, the various embodiments of the present disclosure described above may be performed through an embedded server disposed in the electronic device, or a server disposed outside the electronic device.

Meanwhile, according to an embodiment of the present disclosure, the various embodiments described above may be implemented by software including an instruction stored in a machine-readable storage medium (for example, a computer-readable storage medium). A machine may be a device that invokes the stored instruction from the storage medium, may be operated based on the invoked instruction, and may include the electronic device (e.g., electronic device 100) according to the disclosed embodiments. If the instruction is executed by the processor, the processor may directly perform a function corresponding to the instruction or other components may perform the function corresponding to the instruction under the control of the processor. The instruction may include codes generated or executed by a compiler or an interpreter. The machine-readable storage medium may be provided in the form of a non-transitory storage medium. Here, the term “non-transitory” indicates that the storage medium is tangible without including a signal, and does not distinguish whether data are semi-permanently or temporarily stored in the storage medium.

In addition, according to an embodiment of the present disclosure, the methods in the various embodiments described above may be provided by being included in a computer program product. The computer program product may be traded as a product between a seller and a purchaser. The computer program product may be distributed in the form of a storage medium (for example, a compact disc read only memory (CD-ROM)) capable of being read by the machine or online through an application store (for example, PlayStore™). In case of the online distribution, at least portions of the computer program product may be at least temporarily stored in a storage medium such as a memory of a server of a manufacturer, a server of an application store or a relay server, or be temporarily provided.

In addition, each of the components (for example, modules or programs) according to the various embodiments described above may include one entity or a plurality of entities, and some of the corresponding sub-components described above may be omitted or other sub-components may be further included in the various embodiments. Alternatively or additionally, some of the components (e.g., modules or programs) may be integrated into one entity, and may perform functions performed by the respective corresponding components before being integrated in the same or similar manner. Operations performed by the modules, the programs, or other components according to the various embodiments may be executed in a sequential manner, a parallel manner, an iterative manner, or a heuristic manner, at least some of the operations may be performed in a different order or be omitted, or other operations may be added.

Although the embodiments are shown and described in the present disclosure as above, the present disclosure is not limited to the above-mentioned specific embodiments, and may be variously modified by those skilled in the art to which the present disclosure pertains without departing from the gist of the present disclosure as claimed in the accompanying claims. These modifications should also be understood to fall within the scope and spirit of the present disclosure.

What is claimed is:

1. An electronic device comprising:
a display; and
at least one processor configured to:
control the display to display a user interface (UI) screen including a plurality of graphic user interface (GUI) items and indicating a focus GUI as any one GUI item among the plurality of GUI items, and
control the display to move and display the plurality of GUI items in one direction based on a predetermined navigation input,
wherein the at least one processor is configured to:
identify size information of the plurality of GUI items which are included in a section to be scrolled based on the predetermined navigation input,
identify a scroll speed based on the size information of the plurality of GUI items, and
control the display to move and display the plurality of GUI items along one direction based on the scroll speed.

2. The electronic device as claimed in claim 1, wherein the at least one processor is configured to:
identify the scroll speed based on width information of the plurality of GUI items provided a scroll direction corresponding to the predetermined navigation input being a horizontal direction, and
identify the scroll speed based on height information of the plurality of GUI items provided the scroll direction corresponding to the predetermined navigation input being a vertical direction.

3. The electronic device as claimed in claim 1, wherein the at least one processor is configured to:
identify a minimum time required for a motion based on a value acquired by dividing a size of a smallest GUI item among the plurality of GUI items by the scroll speed, and
update the scroll speed based on a perceivable motion time provided the minimum time required for the motion is less than a predetermined perceivable motion time.

4. The electronic device as claimed in claim 1, wherein the plurality of GUI items are first GUI items and the at least one processor is configured to:
identify size information of second GUI items included in the section to be scrolled based on a second navigation input being identified after a scroll based on a first navigation input ends, and
update the scroll speed based on the size information of the plurality of second GUI items.

5. The electronic device as claimed in claim 1, wherein the at least one processor is configured to:
re-identify the section to be scrolled based on an update time point provided the plurality of GUI items included in the section to be scrolled are updated based on at least one of real-time loading of GUI items or looping of the GUI items while a scroll based on the predetermined navigation input is in progress, and
update the scroll speed based on size information of other GUI items included in the re-identified section to be scrolled.

6. The electronic device as claimed in claim 1, wherein the at least one processor is configured to update the scroll speed based on the scroll speed and information on a difference between a size of the display and a predetermined size provided the display has the predetermined size or more.

7. The electronic device as claimed in claim 1, wherein the display is implemented as a rotatable display, and
the at least one processor is configured to:
control the display to move and display the plurality of GUI items in one direction based on the scroll speed while the display has a landscape mode,
correct the scroll speed by reducing the scroll speed based on width information of the display in a portrait mode provided the display is rotated to the portrait mode, and
control the display to move and display the plurality of GUI items in one direction based on the corrected scroll speed while the display has the portrait mode.

8. The electronic device as claimed in claim 1, wherein the at least one processor is configured to control the display to move and display a plurality of first pixels corresponding to the plurality of GUI items and a plurality of second pixels each corresponding to an extra region between the plurality of GUI items in one direction at a constant speed based on the scroll speed.

9. The electronic device as claimed in claim 1, wherein the at least one processor is configured to identify the scroll speed based on the size information of the plurality of GUI items and a basic scroll speed corresponding to the plurality of GUI items, and
basic scroll speed information of the plurality of GUI items is speed information calculated based on a scroll time equally allocated to the plurality of GUI items and a number of pixels included in the plurality of GUI items in a scroll direction of the predetermined navigation input.

10. The electronic device as claimed in claim 1, wherein
the size information of the plurality of GUI items includes at least one of width or height information and ratio information,
ratios or sizes of at least some GUI items among the plurality of GUI items are different from each other, and
the predetermined navigation input corresponds to a user input for continuously moving the plurality of GUI items.

11. A method of providing a user interface (UI) of an electronic device, the method comprising:
displaying a user interface (UI) screen including a plurality of graphic user interface (GUI) items and indicating a focus GUI as any one GUI item among the plurality of GUI items; and
identifying scroll speed information and size information of the plurality of GUI items included in a section to be scrolled based on a predetermined navigation input;
identifying a scroll speed based on the size information of the plurality of GUI items; and
moving and displaying the plurality of GUI items along one direction based on the scroll speed.

12. The method as claimed in claim 11, wherein in the identifying of the scroll speed,
the scroll speed is identified based on width information of the plurality of GUI items provided a scroll direction corresponding to the predetermined navigation input is a horizontal direction, and
the scroll speed is identified based on height information of the plurality of GUI items provided the scroll direction corresponding to the predetermined navigation input is a vertical direction.

13. The method as claimed in claim 11, further comprising:
identifying a minimum time required for a motion based on a value acquired by dividing a size of a smallest GUI item among the plurality of GUI items by the scroll speed; and
updating the scroll speed based on a perceivable motion time provided the minimum time required for the motion is less than a predetermined perceivable motion time.

14. The method as claimed in claim 11, wherein the plurality of GUI items are first GUI items and the method further comprises:
identifying size information of a plurality of second GUI items included in the section to be scrolled based on a second navigation input provided the second navigation input is identified after a scroll based on a first navigation input ends; and
updating the scroll speed based on the size information of the plurality of second GUI items.

15. A non-transitory computer readable medium storing a computer instruction that causes an electronic device to perform an operation when executed by a processor of the electronic device, the operation comprising:
displaying a user interface (UI) screen including a plurality of graphic user interface (GUI) items and indicating a focus GUI as any one GUI item among the plurality of GUI items, and
identifying scroll speed information and size information of the plurality of GUI items included in a section to be scrolled based on a predetermined navigation input,
identifying a scroll speed based on the size information of the plurality of GUI items, and
moving and displaying the plurality of GUI items along one direction based on the scroll speed.

16. The non-transitory computer-readable medium as claimed in claim 15, wherein in the identifying of the scroll speed,
the scroll speed is identified based on width information of the plurality of GUI items provided a scroll direction corresponding to the predetermined navigation input is a horizontal direction, and
the scroll speed is identified based on height information of the plurality of GUI items provided the scroll direction corresponding to the predetermined navigation input is a vertical direction.

17. The non-transitory computer-readable medium claimed in claim 15, the operation further comprising:
identifying a minimum time required for a motion based on a value acquired by dividing a size of a smallest GUI item among the plurality of GUI items by the scroll speed; and
updating the scroll speed based on a perceivable motion time provided the minimum time required for the motion is less than a predetermined perceivable motion time.

18. The non-transitory computer-readable medium as claimed in claim 15, wherein the plurality of GUI items are first GUI items and the operation further comprising:
identifying size information of a plurality of second GUI items included in the section to be scrolled based on a second navigation input provided the second navigation input is identified after a scroll based on a first navigation input ends; and
updating the scroll speed based on the size information of the plurality of second GUI items.

19. The non-transitory computer-readable medium as claimed in claim 15, wherein the operation further comprising:
re-identifying the section to be scrolled based on an update time point provided the plurality of GUI items included in the section to be scrolled are updated based on at least one of real-time loading of GUI items or looping of the GUI items while a scroll based on the predetermined navigation input is in progress, and
updating the scroll speed based on size information of other GUI items included in the re-identified section to be scrolled.

20. The non-transitory computer-readable medium as claimed in claim 15, wherein the operation further comprising:
updating the scroll speed based on the scroll speed and information on a difference between a size of the display and a predetermined size provided the display has the predetermined size or more.
